(19) United States
(12) Patent Application Publication
(10) Pub. No.: US 2014/0369023 A1
(43) Pub. Date: Dec. 18, 2014

(54) LASER-PHOSPHOR DEVICE WITH LASER ARRAY

(71) Applicant: OSRAM GmbH, Muenchen (DE)

(72) Inventor: Henning Rehn, Berlin (DE)

(73) Assignee: OSRAM GMBH, München (DE)

(21) Appl. No.: 14/356,892

(22) PCT Filed: Sep. 20, 2012
(86) PCT No.: PCT/EP2012/068553

§ 371 Date: May 8, 2014

(30) Foreign Application Priority Data
Nov. 9, 2011 (DE) 10 2011 085 978.0

(51) Int. Cl. F21V 9/08; F21V 5/00; F21V 7/00; F21V 13/02

(52) U.S. Cl. CPC F21V 9/08; F21V 13/02; F21V 5/008; F21V 7/0033
USPC 362/84

(57) ABSTRACT

A laser-phosphor device is disclosed wherein laser radiation from a laser array is transmitted via a collimating primary optical unit and via an imaging optical system onto a phosphor layer. The laser arrangement has a plurality of lasers, for example laser diodes. Via the imaging optical system, a reduced imaging of the laser radiation distribution of the primary optical unit is produced on the phosphor layer.

### RELATED APPLICATIONS

The present application is a national stage entry according to 35 U.S.C. §371 of PCT application No.: PCT/EP2012/068553 filed on Sep. 20, 2012, which claims priority from German application No.: 102011085978.0 filed on Nov. 9, 2011, and is incorporated herein by reference in its entirety.

### TECHNICAL FIELD

Various embodiments relate to a laser-phosphor device having a laser array, for example a laser diode array, the radiation of which is directed onto a phosphor layer in order to stimulate the latter to shine. The term laser array is intended to mean an arrangement of a multiplicity of lasers. The individual lasers of the laser array may be the same as one another or different to one another

### BACKGROUND

The related art discloses laser-phosphor devices in which a laser spot is generated on a phosphor layer by means of various optics, so that the phosphor layer is excited and emits light. Such laser-phosphor devices are used, for example, as light sources. In this case, the laser radiation is guided through primary optics and through an optical system, before it strikes the phosphor layer. The laser radiation collimated by the primary optics is in this case focused through the optical system to form a laser spot. The converted light generated at the position of the spot on the phosphor is delivered through a converging optical system to an application.

The idea of using laser radiation is that it can be concentrated onto a small area (spot) and generates useful light with a high luminous density there with the aid of a phosphor. The converging optical system therefore only processes light from the region of the spot. Any displacement or enlargement of the spot therefore leads to a reduction of the useful light. These displacements or enlargements of the spot may, for example, be caused by placement, shape and position tolerances of the lasers and of the primary optics.

### SUMMARY

Various embodiments provide a laser-phosphor device in which the tolerances, in particular position tolerances, of the primary optics collimating the laser radiation have up to a certain extent no effects on the position and size of the laser spot on the phosphor.

In the laser-phosphor device according to the disclosure, laser radiation (for example coherent light, i.e. laser radiation in the visible range, or coherent electromagnetic radiation in the ultraviolet (UV) or infrared (IR) range) of a laser array can be transmitted via primary optics and via an imaging optical system onto a phosphor layer. The laser array has a multiplicity of lasers, for example laser diodes, which can emit laser radiation with the same wavelength and/or different wavelengths. The imaging optical system is configured in such a way that the part, passed through by the laser beam, of a plane which extends perpendicularly to the optical axis of the system and lies at least in the vicinity of the primary optics, preferably in the primary optics or in the light path immediately after the primary optics, can be imaged with reduction onto the phosphor layer. In other words, the spot generated by the optical imaging system is the reduced optical image of the radiation distribution in the aforementioned plane through which the laser beam passes, i.e. ultimately the radiation distribution of the primary optics. In this way, small position deviations of the primary optics can be tolerated since they do not lead to any enlargement or position displacement of the spot, but merely alter the angle of incidence of the laser light on the phosphor.

In this case, it has been found advantageous for the imaging to take place with reduction approximately on a scale of 1:40.

In order to collimate respective light emitted by the assigned laser, preferably a laser diode, the primary optics preferably have a multiplicity of converging lenses, a converging lens being assigned to each laser or laser diode. In other words, the primary optics are preferably configured as an array of collimated primary optical elements, preferably converging lenses, which corresponds to the laser array.

In a preferred refinement, each converging lens includes two convexly curved surfaces, one of which is aspherical.

The optical imaging of the laser-phosphor device according to the disclosure is preferably telecentric on both sides.

In a preferred variant, the imaging optical system has a positive lens or positive lens group, a negative lens or negative lens group, and a subsequent positive lens or positive lens group.

In another preferred variant, the imaging optical system consists of a telescope arrangement having two mirrors (reflecting telescope).

In this case, the multiplicity of laser diodes may be arranged in annularly around the convexly curved mirror.

In a first variant, the hollow mirror arrangement has a concavely curved hollow mirror having a central opening.

In a second variant, the hollow mirror arrangement has a multiplicity of hollow mirrors, a hollow mirror being assigned to each laser diode.

In another variant, the output takes place laterally, for example in the manner of a newtonian or Nasmyth telescope arrangement.

In order to avoid hot spots on the phosphor, which could occur owing to sharp imaging of the individual laser diodes or of the assigned converging lenses, the imaging may be slightly defocused so that the imaging is a little blurred and the irradiation strength distribution is rendered uniform. Furthermore, in this context it is advantageous for the lasers with the assigned primary optical elements to be arranged uniformly, preferably hexagonally or rectangularly, particularly in a square.

The disclosure is not limited to laser diodes, but may include all types of laser light sources, i.e. for example: gas lasers, solid-state lasers, fiber lasers. Furthermore superluminescent diodes having essentially parallel beam emission are also intended to be included here under the term laser.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a first embodiment of the laser-phosphor device according to the disclosure;

FIG. 2 shows a second embodiment of the laser-phosphor device according to the disclosure;

FIG. 3 shows a spot of the two embodiments according to FIG. 1 and FIG. 2; and

FIG. 4 shows a part of a third embodiment of the laser-phosphor device according to the disclosure.

### DETAILED DESCRIPTION

The following detailed description refers to the accompanying drawing that show, by way of illustration, specific details and embodiments in which the disclosure may be practiced.

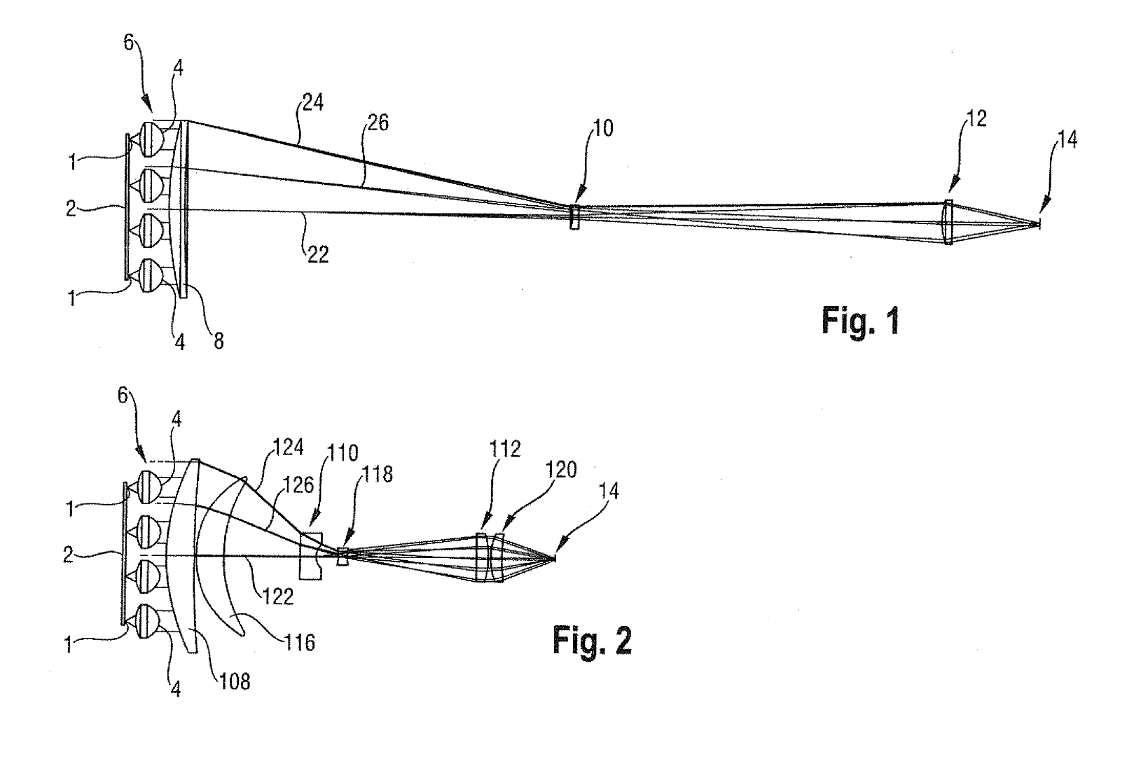

FIG. 1 shows a first embodiment of a laser-phosphor device according to the disclosure in a schematic lateral view. It has an approximately rectangular array 2 of laser diodes 1, of which a shorter side edge is represented in FIG. 1. Twenty-four blue-emitting laser diodes 1 are arranged on the array 2.

These are distributed uniformly on the array 2 with the format 40 mm*60 mm.

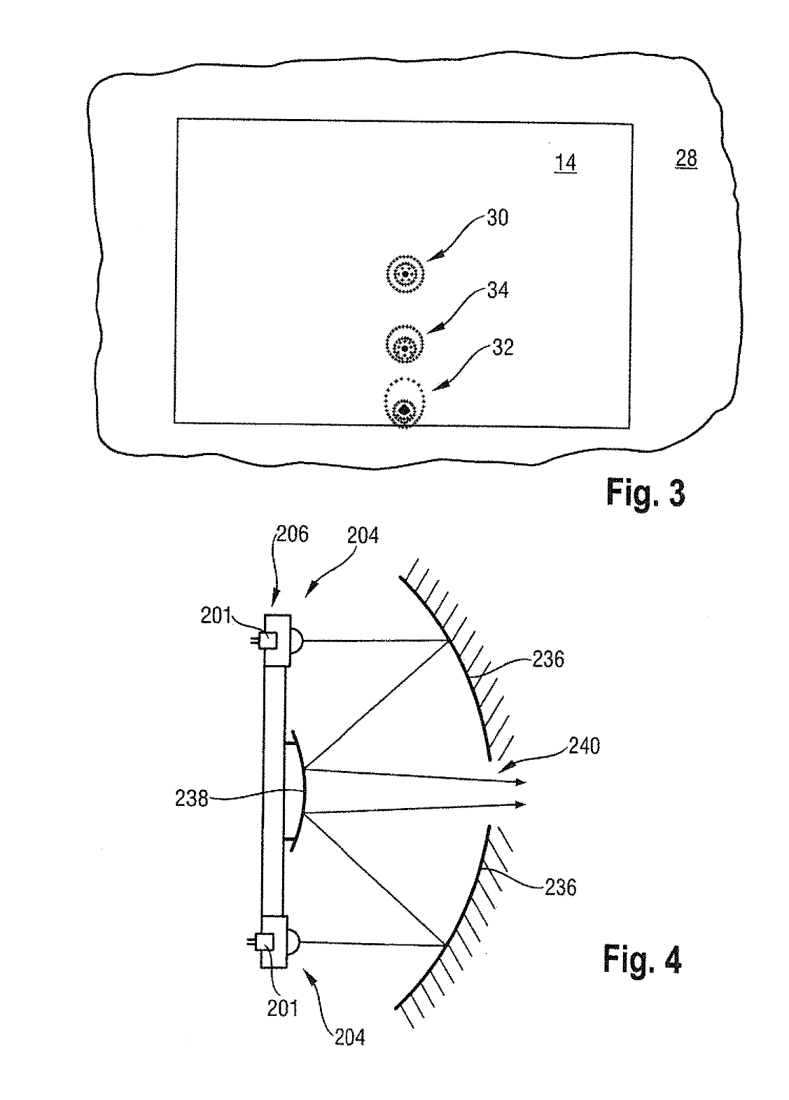

Each laser diode 1 of the laser diode array 2 is assigned a biconvex converging lens 4, the twenty-four converging lenses 4 forming primary optics 6 in the form of a primary lens array. Via the converging lenses 4, each of which has a diameter of 6 mm, the light of each assigned laser diode 1 is collimated. An imaging optical system consisting of the lenses 8, 10 and 12 images the surface of the primary lens array on a reduced scale as a spot (14) on the phosphor (28, see also FIG. 3) arranged there. The latter is stimulated to shine according to the illumination, or irradiation, by the blue laser light of the array 2. In this case, the surface of the array 2 is imaged from the plane of the primary lenses 4 on a scale of 1:40 as a spot on the phosphor layer.

FIG. 2 shows a second embodiment of the laser-phosphor device according to the disclosure. In this case, the essential difference from the first embodiment according to FIG. 1 is that further lenses are used in the beam path between the array 2 and the spot 14. Furthermore, the first converging lens 108, the diverging lens 110 and the second converging lens 112 have been modified. Overall, by the modified imaging optical system 108, 116, 110, 118, 112, 120, the distance between the array 2 and the spot 14, or the phosphor layer (28, see also FIG. 3) arranged on the spot, has been shortened in comparison with the first embodiment. The larger number of lenses offers a strong refractive power and shorter focal lengths. In this way, with the same imaging quality, the overall length of the second embodiment is shortened in comparison with the first embodiment.

FIGS. 1 and 2 respectively show a central ray bundle 22 and 122, respectively, a marginal ray bundle 24 and 124, respectively, and a further ray bundle 26 and 126, respectively, extending between them.

FIG. 3 shows the performance of the reduced imaging and the spot 14, imaged on a reduced scale according to the disclosure in comparison with the size of the array 2, on the phosphor layer 28. The spot 14 shown is generated by the first embodiment according to FIG. 1 and by the second embodiment according to FIG. 2. By way of example, the incidence positions of the three ray bundles 22, 24, 26 and 122, 124, 126, respectively, are shown in the spot 14. The incidence position of the central ray bundle 22 or 122 is marked by the reference 30, the incidence position of the outer ray bundle 24 or 124 is marked by the reference 32, and the incidence position of the ray bundle 26 or 126 lying between them is denoted by the reference 34.

With a maximum angle divergence of ±0.5° relative to the optical axis (which corresponds to the horizontal in the plane of the drawing) of the light after the primary optics 6 amounts to about 20° on the selected imaging scale of 1:40 of the full angle of incidence on the phosphor layer. With a maximum lateral centering error (i.e. in a plane perpendicular to the plane of the drawing) of 20 μm for one or more of the converging lenses 4 of the primary optics 6, the divergence is increased by 0.6°, i.e. up to ±1.1°. Nevertheless, according to the disclosure the position and the size of the spot 14 on the phosphor layer 28 does not change; it is merely that the angle of incidence increases from 20° (with divergence of ±0.5° to 50° (corresponding to a divergence of ±1.1°. The imaging optical system 8, 10, 12 or 108, 116, 110, 118, 112, 120, respectively, is configured in such a way that these 50° are still transmitted on the spot side. In this way, the effects of the position tolerances of the converging lenses 4 of the primary optics 6 are eliminated, assuming that the extent of the tolerances is not so great that the imaging optical system can no longer transmit the light.

Similarly, the position and the size of the spot (14) on the phosphor layer (28) is preserved by the arrangement according to the disclosure even if centering errors due to adjustment inaccuracies of one or more converging lenses (4) of the primary optics (6) parallel to the optical axis, and adjustment inaccuracies due to tilting of the primary lenses, occur.

FIG. 4 shows a third embodiment of the laser-phosphor device according to the disclosure in a lateral sectional representation. This is a variant of a reflecting telescope. A rotationally symmetrical laser diode arrangement has a multiplicity of annularly arranged laser diodes 201, of which only two laser diodes 201 are shown in FIG. 4. Each laser diode 201 is assigned a converging lens 204, which together form the primary optics. In FIG. 4, of two converging lenses 204, the convexly curved aspherical surface is respectively represented. The laser diodes 201 are arranged concentrically around the optical axis.

In the third embodiment, the primary lens plane through which the laser radiation of the laser diodes (201) passes is imaged on a reduced scale by means of a reflecting telescope-like arrangement. First, the light oriented parallel by the converging lenses 204 is reflected by a concavely curved hollow mirror 236 into a central region inside the annular laser diode arrangement. Arranged there, there is a convexly curved mirror 238 by which the light rays are directed in a collimate fashion through an opening 240 of the hollow mirror 236.

In a variant which is not represented, the mirror 238 is likewise concave.

In the third embodiment as well, the arrangement of laser diodes 201 is imaged in the form of a spot of reduced size on the phosphor layer (neither shown in FIG. 4). In this case, a minor position tolerance of the converging lenses 204 of the primary optics leads at most to a slight displacement or enlargement of the spot on the phosphor layer.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A laser-phosphor device, in which the laser radiation of a laser array can be transmitted via primary optics which collimate the laser radiation and via an optical system onto a phosphor layer, the laser array comprising a multiplicity of lasers, wherein the optical system is configured as an imaging optical system with which a reduced image of a part, passed through by the laser beam, of a plane which extends perpendicularly to the optical axis of the system and lies at least in the vicinity of the primary optics can be generated on the phosphor layer.

2. The laser-phosphor device as claimed in claim 1, wherein the primary optics comprise a multiplicity of converging lenses, and wherein a converging lens is assigned to each laser.

3. The laser-phosphor device as claimed in claim 2, wherein each converging lens comprises two convexly curved surfaces, one of which is aspherical.

4. The laser-phosphor device as claimed in claim 1, wherein the imaging optical system has a first converging lens or first converging lens group and, after this in the beam path, a diverging lens or diverging lens group, and, after this in the beam path, a second converging lens or second converging lens group.

5. The laser-phosphor device as claimed in claim 1, wherein the imaging optical system has a hollow mirror arrangement and a convexly curved mirror.

6. The laser-phosphor device as claimed in claim 5, wherein the multiplicity of lasers are arranged in an annular fashion around the convexly curved mirror.

7. The laser-phosphor device as claimed in claim 5, wherein the imaging optical system is a reflecting telescope.

8. The laser-phosphor device as claimed in claim 5, wherein the hollow mirror arrangement is a concavely curved hollow mirror having a central opening.

9. The laser-phosphor device as claimed in claim 5, wherein the hollow mirror arrangement has a multiplicity of hollow mirrors, a hollow mirror being assigned to each laser.

10. The laser-phosphor device as claimed in claim 1, wherein the optical imaging is slightly defocused.

11. The laser-phosphor device as claimed in claim 1, wherein the multiplicity of lasers of the laser array is a multiplicity of lasers..

12. The laser-phosphor device as claimed in claim 1, wherein the lasers of the laser array are arranged uniformly.
